(19) United States
(12) Patent Application Publication
(10) Pub. No.: US 2026/0292417 A1
(43) Pub. Date: Sep. 24, 2026

(54) MINIATURE SPEAKER

(71) Applicant: Sonion Nederland B.V., Hoofddorp (NL)

(72) Inventors: Adrianus Maria LAFORT, Hoofddorp (NL); Koen VAN GILST, Hoofddorp (NL)

(73) Assignee: Sonion Nederland B.V., Hoofddorp (NL)

(21) Appl. No.: 19/472,525

(22) PCT Filed: Apr. 18, 2024
(86) PCT No.: PCT/EP2024/060643

§ 371 Date: Oct. 3, 2025

(30) Foreign Application Priority Data
Apr. 26, 2023 (EP) 23170054.3

(51) Int. Cl. H04R 25/00; H04R 17/00; H04R 19/02

(52) U.S. Cl. CPC H04R 25/604; H04R 17/00; H04R 19/02; H04R 25/602; H04R 25/603; H04R 2201/003

(57) ABSTRACT

The present invention relates to a capacitive MEMS speaker comprising a first sound generating element adapted to deflect in response to electrical energy applied thereto, a second sound generating element adapted to deflect in response to electrical energy applied thereto, and an inductor adapted to store and release electrical energy when electrical energy is transferred between the first and second sound generating elements at least partly via the inductor. The present invention further relates to an associated method for transferring electrical energy between the first and second sound generating elements at least partly via the inductor. Finally, the present invention relates to hearing device comprising a capacitive MEMS speaker.

### FIELD OF THE INVENTION

The present invention relates to a speaker, such as a miniature speaker. In particular, the present invention relates to a capacitive miniature speaker, more preferably a capacitive MEMS speaker. In the speaker according to the invention, energy is transferred between speaker elements in a controlled manner.

### BACKGROUND OF THE INVENTION

In miniature speakers, and in particular miniature speakers for personal audio devices including hearing devices/aids, often referred to as miniature receivers, the amount of available power is limited, in particular where batteries are used to provide power. Thus, there is a need for miniature speakers that are highly efficient, consume as little as possible power. In the hearing aid industry, the term receiver is commonly used to refer to a sound generating receiver, i.e. a speaker. The dimensions of the speaker according to the invention are typically 8×6×4 mm or smaller, preferably 7×3.5×2 mm or smaller, even more preferably 6×3×1.5 mm or smaller. Speakers according to the invention may also be referred to in this description as miniature receivers or miniature speakers.

Miniature speakers may advantageously be based on Micro-Electro-Mechanical-Systems (MEMS) technology as this typically leads to a large bandwidth and low vibrations/deflections due to the low mass of the moving elements. In addition, MEMS technology is advantageous due to its high reproducibility in relation to mass production as well as the possibility of applying standard industry manufacturing processes. However, the need for a highly efficient operation remains, or, in one aspect, is even more important than in other miniature speakers.

Miniature MEMS speakers such as capacitive miniature MEMS speakers, may apply either piezoelectric or electrostatic actuators. However, these actuators are generally disadvantageous due to the inherent weak coupling between the electrical and the mechanical domains. Moreover, compared to typical supply voltage levels, such as battery voltages, these actuators generally require a relatively high voltage, and thus a voltage step-up converter, in order to drive them properly. Even further, the nature of capacitive speakers often leads to dissipation of blind power and thus to low efficiency operation while high efficiency operation is required for, in particular, battery-driven systems where the amount of available power is limited.

It may thus be seen as an object of embodiments of the present invention to provide a highly efficient miniature speaker, in particular a highly efficient capacitive miniature speaker, such as a highly efficient capacitive MEMS speaker.

### SUMMARY OF THE INVENTION

In a first aspect, the present invention provides a speaker, a miniature speaker, comprising
a) a first sound generating element adapted to deflect in response to electrical energy applied thereto,
b) a second sound generating element adapted to deflect in response to electrical energy applied thereto, and
c) an energy transferring element adapted to store and release energy when energy is transferred between the first and second sound generating elements at least partly via the energy transferring element.

Thus, the present invention relates to a speaker, a miniature speaker, such as a capacitive MEMS speaker, adapted to generate sound by transferring energy between the first and the second sound generating elements at least partly via the energy transferring element. The frequency of the generated sound may be in the audible range, i.e. in the frequency range between 20 Hz and 20 KHz.

The first and second sound generating elements may be considered speaker elements of a miniature speaker, or they may be considered speakers themselves depending on the speaker implementation. In order to generate sound, the first and the second sound generating elements are adapted to deflect, and thus generate pressure variations, in response to electrical energy applied thereto.

The energy transferring element, typically, is adapted to store and release electrical energy. The energy transferring element is typically operatively connected to the first and second sound generating elements to transfer (electrical) energy between the first and second sound generating elements. The energy transferring element may comprise an inductor. According to one embodiment, energy may be transferred between the first and second sound generating elements and the energy transferring element in energy portions, which may be considered as discrete energy portions. The discrete energy portions may have essentially the same size, or they may be different. The energy transferring element according to this embodiment is adapted to store and receive discrete energy portions. As will be described in more detail below, preferably, a switching arrangement, more preferably a controllable switching arrangement, is operatively connected to the energy transferring element and the first and second sound generating elements to facilitate and control transfer of energy, in particular transfer of energy portions, discrete energy portions, when energy is transferred between the first and second sound generating elements at least partly via the energy transferring element.

Preferably, a first one of the sound generating elements is adapted to generate a positive pressure on a sound outlet of the speaker when a positive drive voltage relative is applied, whereas the other sound generating element is adapted to generate a positive pressure on the sound outlet when a negative drive voltage is applied.

Preferably, the sound generating elements are of equal size.

The sum of the electrical energy in the first sound generating element, the second sound generating element and the energy transferring element is preferably maintained at an essentially constant level, more preferably over a predetermined time period. Essentially constant in this context means that the change in energy over the predetermined time period is small relative to the total stored energy, preferably less than 10%, such as less than 5%, in particular less than 2%. The predetermined time period may be long relative to the lowest sound frequency to be generated. Miniature speakers for use in hearing devices typically are designed to operate in the range of from 20 Hz to 20 kHz. The lowest sound frequency in this embodiment would be 20 Hz. The predetermined time period is preferably 2 times, more preferably 3 times, even more preferably 4 times, such as at least 5 times or at least 10 times longer than the cycle time of the lowest sound frequency to be generated. Thus, if the lowest sound frequency to be generated is 20 Hz, the predetermined time period is preferably at least 0.1 second, more preferably at least 0.15 second, even more preferably at least 0.2 second, such as at least 0.25 second or at least 0.5 second. Preferably, the predetermined time period is 1 second or more. According to a particularly preferred embodiment, the predetermined time period during which the sum of electrical energy in the first sound generating element, the second sound generating element and the energy transferring element is maintained at an essentially constant level for up to 10 seconds, such as up to 5 seconds. In operation, maintaining electrical energy at an essentially constant level for a prolonged period may be challenging due to electrical losses and design constraints in miniature speakers. In order to maintain the electrical energy at an essentially constant level, energy may be provided to the energy transferring element in order to compensate for electrical losses, such as resistive losses, conducting losses and switching losses, in the system. Further losses in the system may be capacitive losses (on parasitic capacitors), losses due to emitted acoustical energy, and losses due to damping in the acoustical or mechanical domain. This will be discussed in further details below.

With respect to the generated sound, the sum of the deflections of the first sound generating element and the second sound generating element may be substantially linear with a drive voltage applied to the first and second sound generating elements. This linear dependency of the sum of the deflections is an advantageous feature seen from a control scheme.

The first and second sound generating elements may each comprise a piezoelectric actuator or an electrostatic actuator adapted to deflect the respective sound generating elements, and wherein the energy transferring element comprises an inductor. Thus, the inductor may be adapted to store and release energy when energy is transferred between the piezoelectric actuators and/or the electrostatic actuators of the first and second sound generating elements.

The first and second sound generating elements may each comprise a deflection sensor adapted to generate an electrical signal in response to deflections of the respective sound generating elements. The deflection sensor may be an add-on sensor or an integrated sensor, and it may comprise a piezoelectric and/or a piezoresistive readout scheme in response to deflections of the first and second sound generating elements. As it will be discussed in further details below the deflection sensors of the first and second sound generating elements may form part of a feedback control scheme.

The energy transferring element may furthermore be adapted to receive and store energy from an energy source, such as a battery. The energy source may be an external energy source or it may form part of the speaker. As already mentioned, energy may be provided to the energy transferring element in order to compensate for electrical losses so that the sum of the electrical energy in the first sound generating element, the second sound generating element and the energy transferring element may be maintained at an essentially constant energy level over a predetermined time period. Also, at start-up the energy levels in the sound generating elements and the energy transferring element may be brought from an initial energy level to a predetermined constant energy level.

The energy transferring element may also be adapted to provide energy to the energy source if the energy source is able to absorb energy.

In terms of implementation the first and second sound generating elements may be discrete and separate mechanical structures with independent accessible electrical terminals. Separate and distinct rear volumes may be associated with the first and second sound generating elements so that the first sound generating element is acoustically connected to a first rear volume, and that the second sound generating element is acoustically connected to a second and different rear volume. The first and second sound generating elements may be acoustically connected to a common front volume and a sound outlet being acoustically connected thereto.

In another implementation the first and second sound generating elements may each form a bimorph/multimorph mechanical structure, wherein piezoelectric or electrostatic actuators of the first and second sound generating elements may form a stacked mechanical structure. The first and second sound generating elements may still have independent accessible electrical terminals. The stacked arrangement of the actuators may involve that piezoelectric layers sandwiched between electrodes are stacked on top of each other thus forming a bimorph/multimorph mechanical structure.

Piezoelectric speakers applying multimorph actuators comprising multiple piezoelectric layers may thus also be applicable in relation to the first and second sound generating elements. Here a plurality of piezoelectric layers are connected in parallel in order to be driven as one sound generating element, whereas another plurality of piezoelectric layers are connected in parallel in order to be driven as another sound generating element.

In relation to electrostatic actuators terms like asymmetrical/symmetrical or signal/dual backplate may replace the terms monomorph/bimorph.

In order to transfer energy between the first and second sound generating elements and the energy transferring element the speaker may further comprise a controllable switching arrangement operatively connected to at least the energy transferring element and the first and second sound generating elements. The controllable switching arrangement may be adapted to facilitate the transfer of energy between at least the first sound generating element, the second sound generating element and the energy transferring element. The controllable switching arrangement may comprise one or more transistors, such as one or more MOSFETs, and a controller for generating and providing control signals to the one or more transistors. Thus, the speaker may further comprise a controller adapted to control the controllable switching arrangement in a predetermined manner or sequence.

In an embodiment, the speaker further comprises an energy source and a controller adapted to switch the controllable switching arrangement between the following states:
state a) wherein the controllable switching arrangement is arranged to transfer electrical energy from the first sound generating element to the inductor;
state b) wherein the controllable switching arrangement is arranged to transfer electrical energy from the inductor to the second sound generating element;
state c) wherein the controllable switching arrangement is arranged to transfer electrical energy from the second sound generating element to the inductor;
state d) wherein the controllable switching arrangement is arranged to transfer electrical energy from the inductor to the first sound generating element; and
state e) wherein the controllable switching arrangement is arranged to transfer electrical energy from the energy source to the inductor.

In a preferred embodiment, the controller controls the switching arrangement to cycle through a sequence of states a)-d), wherein the switching arrangement switches back to state a) after state d). At any moment during this cycle, the controller can switch the switching arrangement to state e) to add electrical energy from the battery to the inductor, e.g. to compensate for energy losses or to initially provide electrical energy to the system.

In a first example, the controller switches the switching arrangement to state e) after each full cycle through all states a)-d).

In a second example, the controller switches the switching arrangement to state e) after every state a)-d).

In a third example, the controller switches the switching arrangement to state e) at irregular intervals, e.g. whenever it is desired to supplement the electrical energy stored in the inductor. For example, the current through the inductor is measured and used as feedback loop to control switching to state e). For example, the controller determines whether the current through the inductor is below a predetermined threshold current. Preferably, the threshold current is greater than zero. The controller switches the switching arrangement to state e) if it is determined that the current through the inductor is below the predetermined threshold current. In another example, the controller uses an open loop control, wherein the controller estimates the electrical energy stored in the inductor based on the signal voltage. The controller switches the switching arrangement to state e) if the estimation is below a predetermined threshold energy. Preferably, the predetermined threshold energy is greater than zero.

In a second aspect the present invention relates to a method for operating a speaker, a miniature speaker, comprising a first sound generating element adapted to deflect in response to electrical energy applied thereto, a second sound generating element adapted to deflect in response to electrical energy applied thereto, and an energy transferring element adapted to store and release energy, the method comprising the step of transferring energy between the first and second sound generating elements at least partly via the energy transferring element.

Similar to the first aspect the sum of the electrical energy in the first sound generating element, the second sound generating element and the energy transferring element may be maintained at an essentially constant level over a predetermined time period. This predetermined time period may be long relative to the lowest sound frequency to be generated, as set out in more detail hereinabove.

In the method according to the second aspect the step of transferring energy between the first and second sound generating elements may comprise the steps of
1) transferring energy from the first sound generating element to the energy transferring element for temporary storage therein, and
2) releasing at least part of the temporary stored energy in the energy transferring element and transferring the released energy to the second sound generating element.

Moreover, the step of transferring energy between the first and second sound generating elements may further comprise the steps of
1) transferring energy from the second sound generating element to the energy transferring element for temporary storage therein, and
2) releasing at least part of the temporary stored energy in the energy transferring element and transferring the released energy to the first sound generating element.

The electrical energy being transferred between the first sound generating element, the second sound generating element and the energy transferring element may be the entire energy of a sound generating element/energy transferring element, or only a portion thereof. These options are discussed in further details below.

The method according to the second aspect may, at any time, further comprise the step of transferring energy to the energy transferring element from an energy source, such as a battery. As already mentioned, energy may be provided to the energy transferring element in order to compensate for electrical losses, such as resistive losses, conducting losses and switching losses, in the system. Further losses in the system may be capacitive losses (on parasitic capacitors), losses due to emitted acoustical energy, and losses due to damping in the acoustical or mechanical domain.

Energy may be transferred at least between the first sound generating element, the second sound generating element and the energy transferring element using a controllable switching arrangement operatively connected to at least the energy transferring element and the first and second sound generating elements. The controllable switching arrangement may be adapted to facilitate the transfer of energy between at least the first sound generating element, the second sound generating element and the energy transferring element. The controllable switching arrangement may comprise one or more transistors, such as one or more MOSFETs, and a controller for generating and providing control signals to the one or more transistors. Thus, the speaker, miniature speaker, may further comprise a controller adapted to control the controllable switching arrangement in a predetermined manner or sequence.

The first and second sound generating elements may each comprise a piezoelectric actuator or an electrostatic actuator adapted to deflect the respective sound generating elements, and wherein the energy transferring element comprises an inductor.

In a third aspect the present invention relates to a hearing device comprising a speaker, a miniature speaker, according to the first aspect.

In general, the various aspects of the present invention may be combined and coupled in any way possible within the scope of the invention. These and other aspects, features and/or advantages of the present invention will be apparent from and elucidated with reference to the embodiments described hereinafter.

### BRIEF DESCRIPTION OF THE DRAWINGS

The present invention will now be described with reference to the accompanying drawings wherein

FIG. 1 shows a combination of two oppositely driven speakers where the speakers in a) are driven to obtain positive output pressure, whereas in b) the speakers are driven to obtain negative output pressure,

FIG. 2 shows graphs depicting relations between a) a drive voltage supplied to two speakers as a function of signal voltage, b) air displacement of the two speakers (individually and sum) as a function of signal voltage, and c) electrical energy stored in the two speakers (individually and sum) as a function of signal voltage,

FIG. 3 shows graphs showing various waveforms vs. time: a) sinusoidal input signal, b) drive voltage supplied to two speakers corresponding to sinusoidal input signal, and c) air displacement of two speakers (individually and sum) corresponding to sinusoidal input signal,

FIG. 4 shows graphs showing various waveforms vs. time: a) sinusoidal input signal, b) drive voltage supplied to the speakers corresponding to sinusoidal input signal, and c) electrical energy stored in speakers (individually and sum) corresponding to sinusoidal input signal,

FIG. 5 shows an example of a switching arrangement during: a) energy is transferred from speaker 1 to inductor, b) energy is transferred from inductor to speaker 2, c) energy is transferred from speaker 2 to inductor, d) energy is transferred from inductor to speaker 1, and e) energy is transferred from battery to inductor,

FIG. 6 depicts a drive and control system according to the present invention with feedforward,

FIG. 7 depicts a drive and control system according to the present invention with linearization and feedback,

FIG. 8 depicts speakers with integrated sensor for feedback,

FIG. 9 shows examples of piezoelectric MEMS speakers where a) is a single/monomorph speaker including 4 triangular cantilever beams, b) is a bimorph speaker, and c) is single/monomorph speakers mechanically coupled to additional diaphragm,

FIG. 10 shows an example of an implementation of a switch arrangement,

FIG. 11 shows acoustically connected (in series) multiple speakers, and

FIG. 12 shows acoustically connected (in parallel) multiple speakers in a single die.

### DETAILED DESCRIPTION OF THE INVENTION

In general, the present invention relates to a miniature speaker, such as capacitive MEMS speaker, comprising a first sound generating element, a second sound generating element, and an energy transferring element adapted to temporary store and release energy when energy in the form of energy portions are transferred between the first and second sound generating elements. As already mentioned, the energy portions may be considered as discrete energy portions. Moreover, the miniature speaker of the present invention aims at minimizing the energy drawn from an energy source, such as a battery. This may involve that the energy exchange between the speaker elements of the miniature speaker is large relative to the energy drawn from the energy source. This may be achieved by splitting the miniature speaker, such as a capacitive MEMS speaker, into two equally sized halves and thus two equally sized sound generating elements.

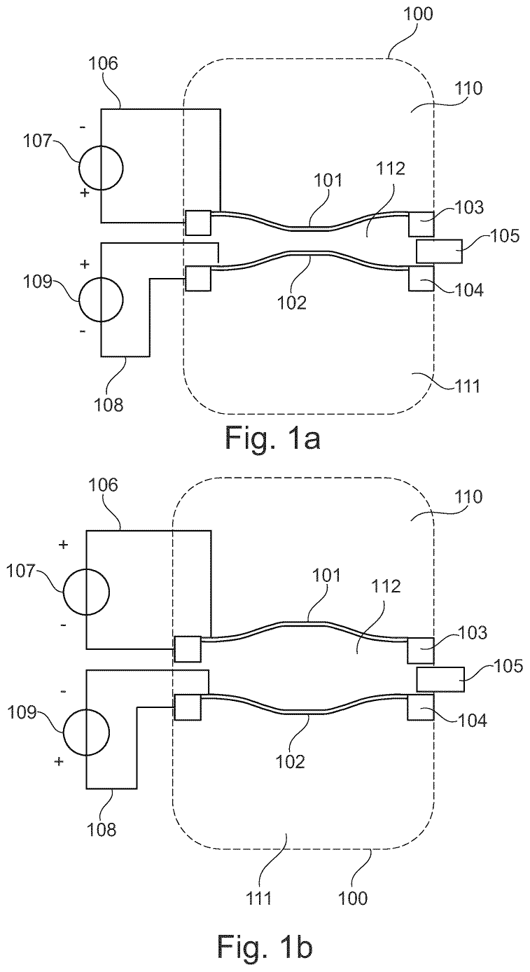

Referring now to FIGS. 1a and 1b a speaker 100 according to an embodiment of the present invention is depicted. The speaker 100 may be considered as comprising two oppositely driven sound generating elements 101, 102 where the direction of deflection of the sound generating elements 101, 102 depends on the applied drive voltage polarity 107, 109 provided via the respective drive circuits 106, 108. In FIG. 1a the sound generating elements 101, 102 are deflected towards each other, whereas in FIG. 1b (with a reversed polarity) the sound generating elements 101, 102 are deflected away from each other. In FIG. 1a the sound generating element 101 is adapted to generate a positive pressure on the sound outlet 105 when a positive drive voltage relative to a bias voltage is applied, whereas the sound generating element 102 is adapted to generate a positive pressure on the sound outlet 105 when a negative drive voltage relative to a bias voltage is applied.

As depicted in FIGS. 1a and 1b the sound generating elements 101, 102 are supported by respective support structures 103, 104. Moreover, a common front volume 112 is provided between the sound generating elements 101, 102, and a common sound outlet 105 is acoustically connected to the common front volume 112. Finally, respective rear volumes 110, 111 are associated with the sound generating elements 101, 102 so that 1) the sound generating element 101 is arranged between the rear volume 110 and the common front volume 112, and that 2) the sound generating element 102 is arranged between the rear volume 111 and the common front volume 112. The two rear volumes 110, 111 may be vented via venting openings or venting filters (not shown) in a speaker housing (not shown) in order to enhance the low frequency output of the miniature speaker. Moreover, the sound generating elements 101, 102 may comprise one or more small openings or perforations (not shown) in order to provide barometric equalization.

The first and second sound generating elements 101, 102 may comprise piezoelectric actuators and/or electrostatic actuators for deflecting the sound generating elements.

The operation and functioning of the speaker 100, including how electrical energy is applied to, and removed from, the sound generating elements 101, 102, will be discussed in detail below. The sound generating elements 101, 102 will in the following be referred to as speakers.

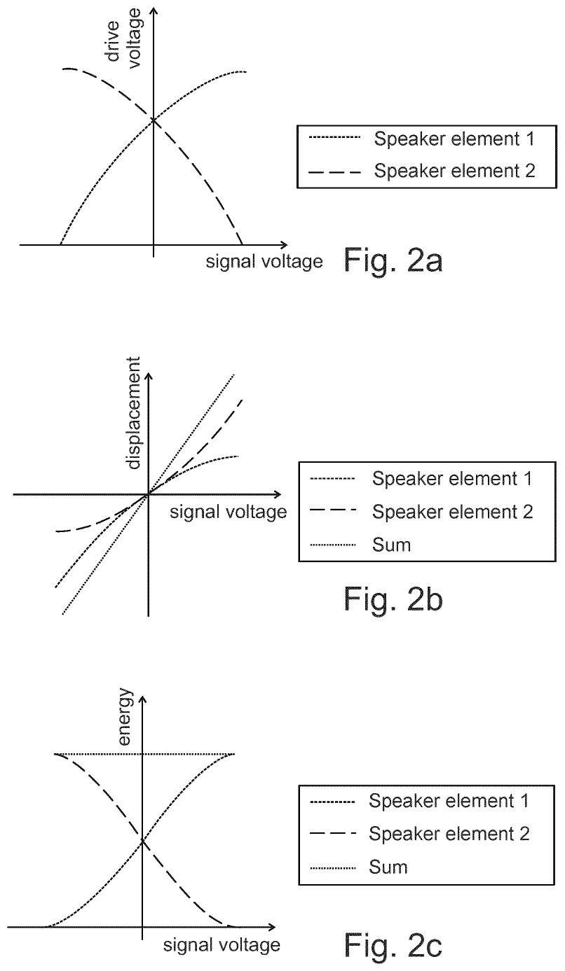

Referring now to FIGS. 2a-c the non-linear relation between the drive voltages (V₁ and V₂) of two speaker elements (speaker 1 and 2) and the normalized signal voltages (Vs) is depicted, cf. FIG. 2a. In the present context the term “drive voltage” means a voltage that is applied to a speaker element, such as the sound generating elements 101, 102, and relates to the electrical energy stored in the speaker element, whereas the term “signal voltage” means a voltage that is provided to the speaker 100 as an input signal with the intention that the acoustical output of the speaker is proportional thereto. The non-linear dependency is evident from FIG. 2a. The drive voltages V₁ and V₂ are given by:

$${V}_{1} = {V}_{m ax} \cdot ( \sqrt{\frac{1}{2} - {( \frac{{V}_{s}}{2} )}^{2}} + \frac{{V}_{s}}{2} )$$

$${V}_{2} = {V}_{ma x} \cdot ( \sqrt{\frac{1}{2} - {( \frac{{V}_{s}}{2} )}^{2}} - \frac{{V}_{s}}{2} )$$

$$with - 1 < {V}_{s} < 1$$

Vₘₐₓ is a predetermined maximum voltage that is applied to the speaker.

FIG. 2b shows the deflection/displacement of each speaker as a function of an applied signal voltage. Moreover, the sum of the deflections/displacements is depicted in FIG. 2b. As depicted in FIG. 2b the deflections/displacements of the speakers are clearly with the signal voltage, whereas the sum of the deflections/displacements is essentially linear with the signal voltage. FIG. 2c shows the electrical energy stored in each speaker as a function of an applied signal voltage. As seen in FIG. 2c the sum of the electrical energy stored in the two speakers (horizontal line) is constant.

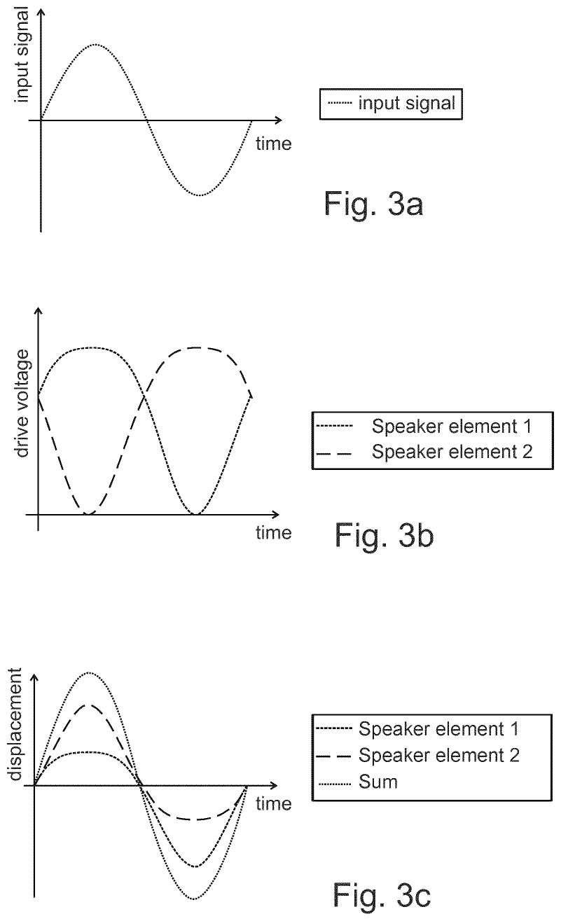

FIGS. 3a-c depict graphs showing various waveforms vs. time where FIG. 3a shows a sinusoidal input signal, FIG. 3b shows the drive voltage supplied to two speakers in response to the sinusoidal input signal, and FIG. 3c shows the air displacement of two speakers (individually and sum) in response to the sinusoidal input signal. As seen, the sinusoidal input signal of FIG. 3a results in a sinusoidal displacement (sum) of the two speakers.

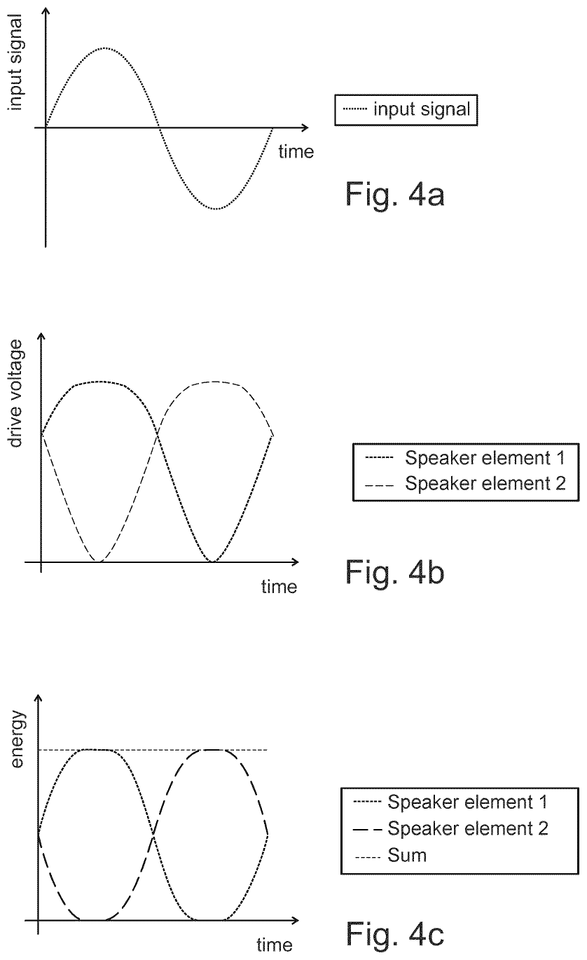

FIGS. 4a-b are similar to FIGS. 3a-b. In FIG. 4c the electrical energy stored in speakers (individually and sum) in response to the sinusoidal input signal is depicted. As seen, the total energy is constant.

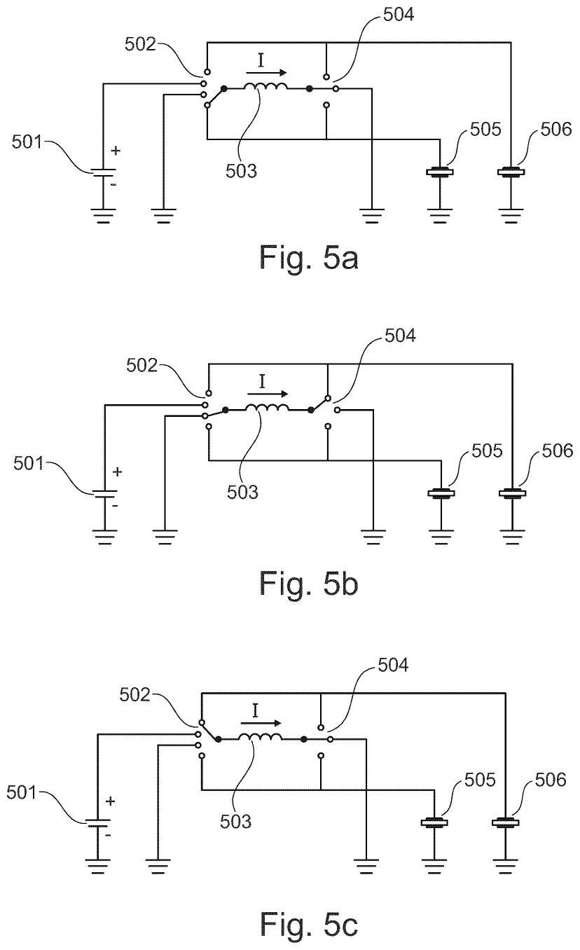

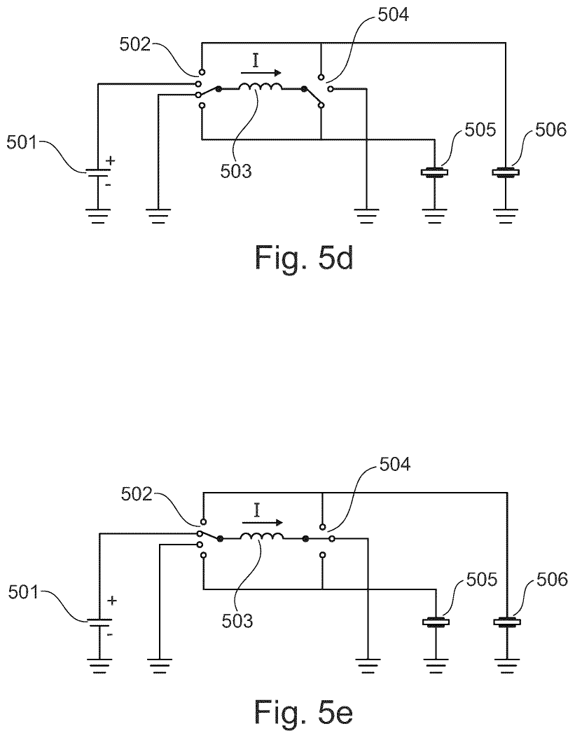

FIGS. 5a-e show the functioning of a miniature speaker according to an embodiment of the present invention. As seen in FIG. 5a the speaker either incorporates or is connected to an energy source 501, such as a battery. Energy may be drawn from the energy source 501 in order to compensate for losses, such as conducting losses and switching losses, in the system. Further losses in the system may be capacitive losses (on parasitic capacitors), losses due to emitted acoustical energy, and losses due to damping in the acoustical or mechanical domain.

An energy transferring element 503 in the form of an inductor is operatively connected to the sound generating elements 505, 506 via two controllable switches 502, 504 so that the energy portions in the form of discrete portions of energy may be transferred between the sound generating elements 505, 506 and the energy transferring element 503 in a controlled manner by means of controlled switching, i.e. opening and closing, of the controllable switches 502, 504. The two controllable switches 502, 504 also facilitate that the energy transferring element 503, i.e. the inductor, may be connected to ground and/or the energy source 501.

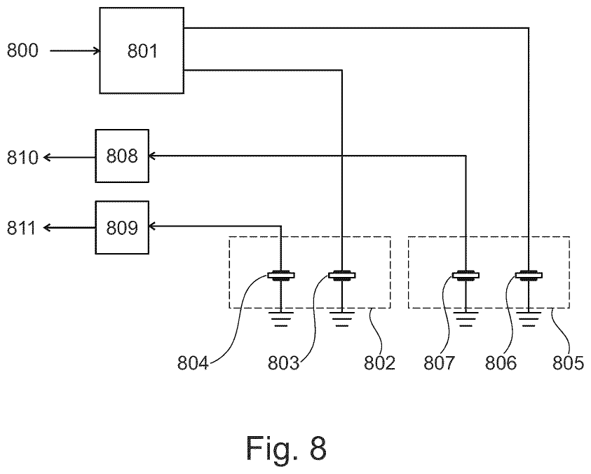

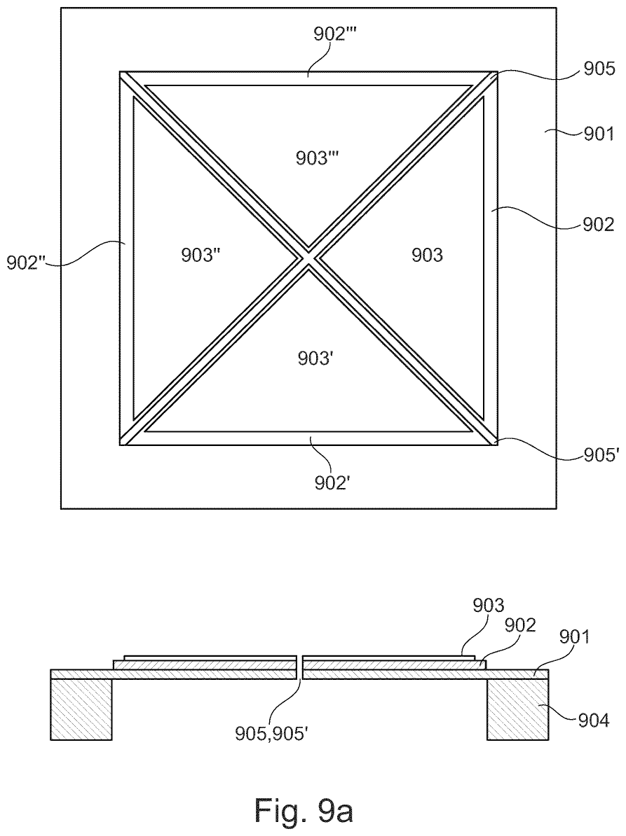

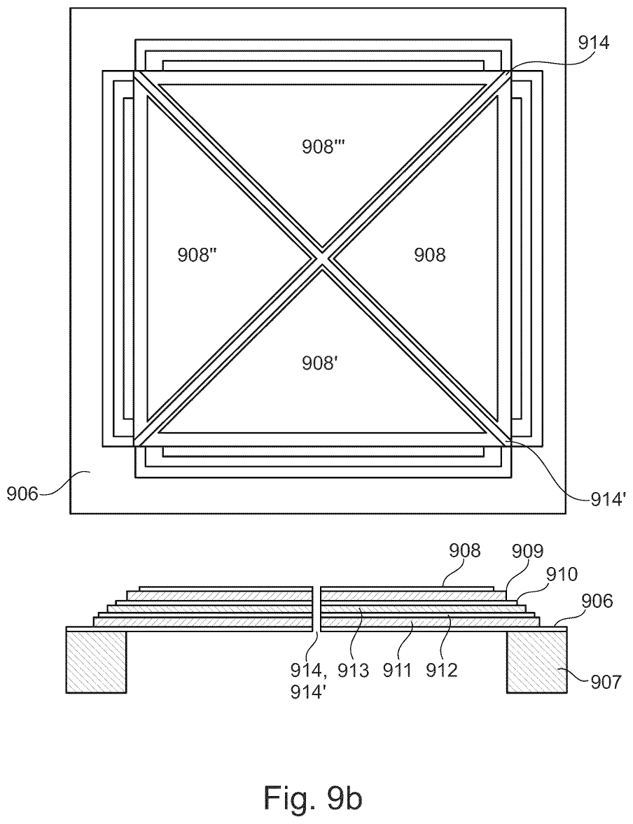

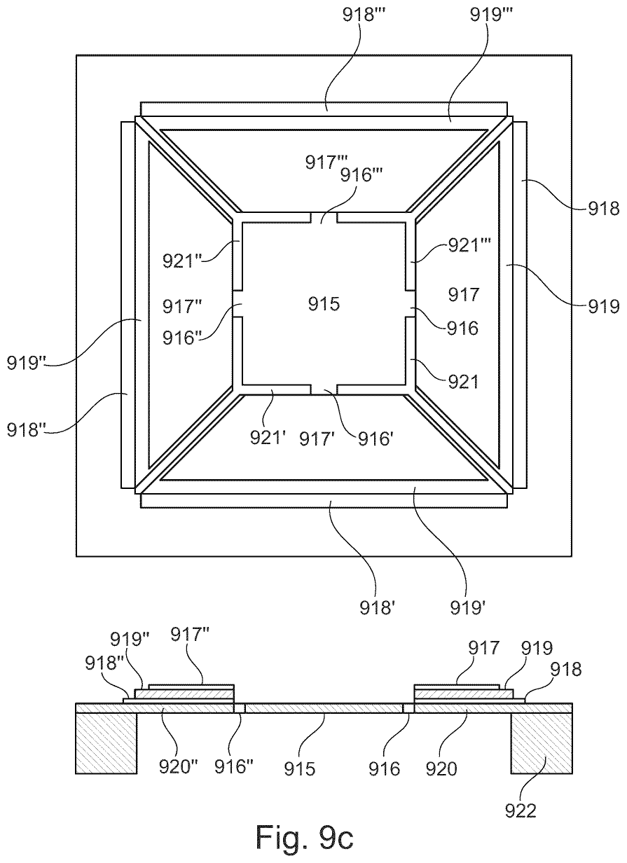

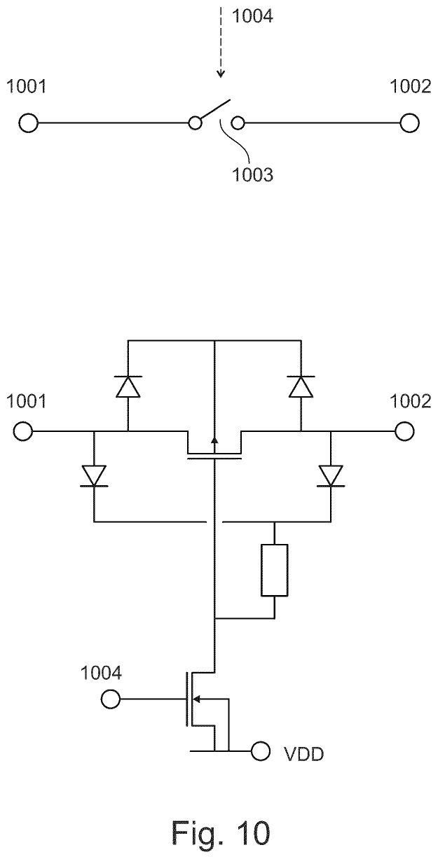

The implementation of the sound generating elements 505, 506 is discussed in detail in relation to FIGS. 8 and 9, and the implementation of the controllable switches 502, 504 is discussed in relation to FIG. 10.

In the following the process of transferring energy portions in the form of discrete portions of energy between the sound generating elements 505, 506 is disclosed.

In FIG. 5a the positioning of the controllable switches 502, 504 facilitates that energy may be transferred from the speaker element or speaker 505 to the inductor 503 for temporary storage therein. During this phase the current through the inductor 503 is increasing, whereas the voltage across the speaker element or speaker 505 is decreasing. In FIG. 5b energy may be released from the inductor 503 and transferred to the speaker element or speaker 506. During this phase the current through the inductor 503 is decreasing, whereas the voltage across the speaker element or speaker 506 is increasing. In FIG. 5c energy may be transferred back from the speaker element or speaker 506 to the inductor 503 for temporary storage therein, and in FIG. 5d energy may again be released from the inductor 503 and transferred to the speaker element or speaker 505. In FIG. 5e energy may be provided to the inductor 503 from the energy source 501 in order to account for electrical losses in the speaker system when transferring energy between the sound generating elements 505, 506. Such electrical losses may involve conduction losses and/or switching losses in the switches 502, 504. As already mentioned further losses in the system may be capacitive losses (on parasitic capacitors), losses due to emitted acoustical energy, and losses due to damping in the acoustical or mechanical domain.

The amount of energy being transferred between the sound generating elements 505, 506 and the energy transferring element 503 may be the entire amount of energy stored in the respective speaker elements/speakers/inductor 505, 506, 503 or only portions thereof. Thus, only a portion of the energy in the sound generating elements 505, 506 or only a portion of the energy temporary stored the energy transferring element 503 may be transferred elsewhere.

Moreover, the rate of the energy transfer in each direction may be affected by the timing of the controllable switches 502, 504, so that the energy transfer may be modulated intermittently. Also, the amount of energy in the discrete energy portions that are transferred between the sound generating elements 505, 506 and the energy transferring element 503 may be small relative to the total amount of energy stored in the speaker. The duration of each phase in the energy transferring process (between the sound generating elements 505, 506 and the energy transferring element 503) may be short relative to the sound signal frequency. Even further, the change in drive voltage applied to the sound generating elements 505, 506 during each phase in the energy transferring process may be small relative to the maximum voltage swing that is applied to the speaker. All this helps to achieve accurate sound reproduction without audible switching artifacts.

With reference to FIGS. 5a-e the drive system involving the inductor 503 and the controllable switches 502, 504 is thus used to transfer energy portions in the form of discrete portions of energy between the two the sound generating elements 505, 506. It is evident that at the maximum drive level, and depending of the polarity of the drive level, the amount of energy in one of the sound generating elements is at its maximum while the amount of energy in the other sound generating elements at that instant is at its minimum, cf. FIG. 2c.

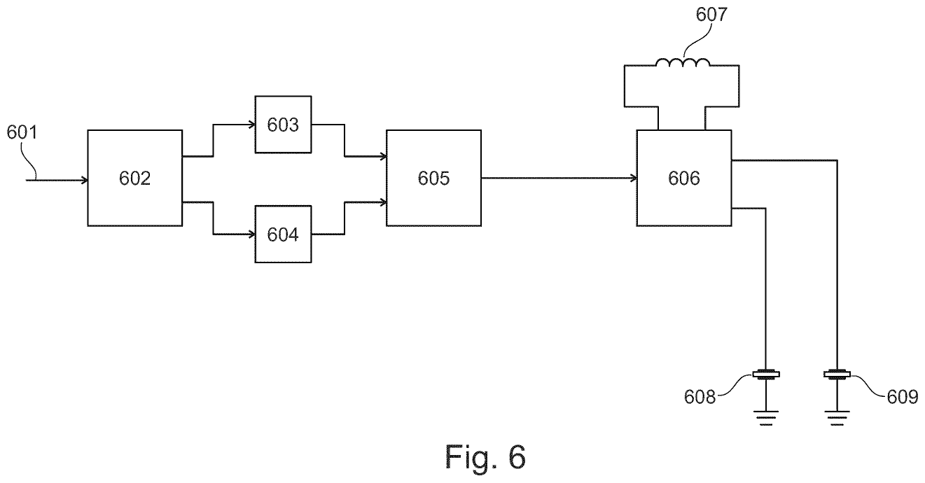

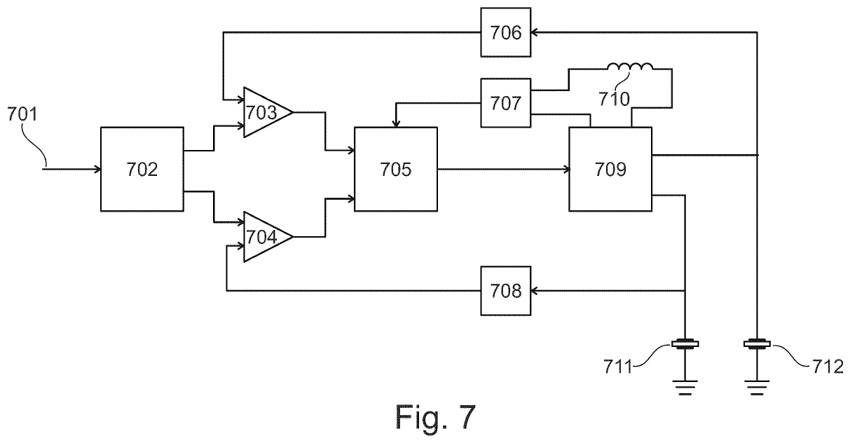

The drive system of the miniature speaker is fitted with a control system that ensures that the sum of the energy stored in the two sound generating elements 505, 506 is kept essentially constant, cf. FIG. 2c, while at the same time also the sum of the contributions of both sound generating elements 505, 506 to the overall sound output is proportional to the input signal. The control system will be discussed in relation to FIGS. 6 and 7.

The effect of the control system is that the voltage driving the sound generating elements is not linear with the signal, cf. FIG. 2a, and that the sound generating elements do not deliver the same contribution to the output over the amplitude range. However, the sum of the contributions is linear with the signal, cf. FIG. 2b, at least when the sound generating elements themselves are linear.

Referring now to FIG. 6 a feed forward drive and control system according to an embodiment of the present invention is depicted. Starting from the left in FIG. 6 the signal input/voltage 601 is provided to a constant energy function 602 which generates two outputs signal which are both passed through a sigma/delta (A/D) converter 603, 604 before entering the control system 605. The role of the constant energy function 602 is to ensure that the total amount of energy in the system is maintained at an essentially constant value as at least partly depicted in FIG. 2c. The constant energy function 602 fulfils its role by receiving energy from an energy source (not shown) in order to compensate for losses in the system. Losses in the system may, as already mentioned, be resistive losses (on analog switches and inductor), capacitive losses (on parasitic capacitors), losses due to emitted acoustical energy, and losses due to damping in the acoustical or mechanical domain.

Constant energy and linear sound output from the sound generating elements 608, 609 may be provided by 1) varying the sequence in which the different energy transfer phases are enabled, and 2) varying the timing during which the different energy transfer phases are enabled based on the input signal and a-priory knowledge of the characteristics of all the elements of the speaker. The feed-forward approach depicted in FIG. 6 may comprise a predistortion function (preceding the constant energy function 602) in order to compensate for known non-linearity in the voltage-to-deflection transfer of the sound generating elements 608, 609.

The control system 605 provides a control signal to the drive system 606 which is adapted to control how energy is transferred between the energy transferring element 607 and the two sound generating elements 608, 609 as also discussed in relation to FIG. 5. The feed forward drive and control system according to the embodiment depicted in FIG. 6 is advantageous due to for example its simple layout.

Turning now to FIG. 7 a feedback-based drive and control system according to another embodiment of the present invention is depicted. Starting again from the left in FIG. 7 the signal input/voltage 701 is provided to a predistortion function 702 which generates two outputs signal which are passed to respective feedback amplifiers 703, 704 before entering the control system 705. The role of the predistortion function 702 is to compensate for non-linearities, cf. FIG. 2b, in the two sound generating elements 711, 712—more particularly to compensate for a known non-linearity in the voltage-to-deflection transfer function of the two sound generating elements 711, 712 in case the feedback signal is derived from the drive voltage applied to the sound generating elements 711, 712. In case the feedback signal is derived from an actual deflection of the sound generating elements 711, 712 the predistortion function 702 is not necessary since the distortion is compensated by the feedback loop. The control system 705 provides a control signal to the drive system 709 which is adapted to control how energy is transferred between the energy transferring element 710 and the two sound generating elements 711, 712 as also discussed in relation to FIG. 5. In general, constant energy and linear sound output from the sound generating elements 711, 712 may be provided by 1) varying the sequence in which the different energy transfer phases are enabled, and 2) varying the timing during which the different energy transfer phases are enabled based on the output of the feedback amplifiers 703, 704.

As depicted in FIG. 7 the current in the energy transferring element 710 is measured in the function block 707 and fed back to the control system 705 as an inner feedback loop. In addition to this inner current feedback loop two outer voltage feedback loops from the respective sound generating elements 711, 712 are provided via respective signal conditioners 706, 708. The two outer voltage feedback loops provide voltage information about the respective sound generating elements 711, 712 to the respective feedback amplifiers 703, 704. The feedback-based drive and control system according to the embodiment depicted in FIG. 7 is advantageous in that the current in the energy transferring element 710 and the voltages of the sound generating elements 711, 712 are fed back for control purposes. Further advantages are that a more accurate control of the drive voltages is provided, and that no a-priory knowledge of the characteristics of all speaker elements of the speaker is required.

In the embodiments depicted in FIGS. 5-7 the two sound generating elements may be a single speaker that has been split or divided into two speaker halves. Firstly, splitting the speaker is advantageous over conventional systems in that it reduces the peak current in energy transferring element/inductor by 50%. The energy transferred through the inductor is thus also reduced by 50%. Secondly, the control system may be adapted to minimize the energy storage in the inductor, and, as a consequence, the dimensions of the inductor can be minimized. Finally, no additional capacitor is needed for energy storage.

Moreover, the embodiments depicted in FIGS. 5-7 allow different implementations of the control system and the drive system.

The drive system of FIG. 5 may in general be characterized by the way the capacitive sound generating elements 505, 506 are connected to the inductor 503 by means of analog controllable switches 502, 504, and the way the energy source 501 is connected to the inductor 503. It is noted that the direction of current through the inductor 503 remains the same.

In one embodiment the energy stored in the inductor 503 is completely transferred to one of the sound generating elements 505, 506 so that the current after the energy transfer is zero. In that case the current through the inductor 503 may have the opposite direction in the next energy transfer cycle, thus reducing the number of analog switches needed.

In another embodiment the energy transfer from the inductor 503 is terminated before completion, and the inductor current is switched to feed into another terminal (e.g. another speaker element or speaker, the energy source 501, or ground). For the next energy transfer cycle the connections must be switched so that the current through the inductor 503 continues in the same direction whereby a larger number of analog switches is needed. The advantage of this more complex approach is however that the voltage swing that can be achieved on the speakers can be larger.

The control system of FIGS. 6-7 may in general be characterized by the way that the required waveforms are obtained by means of switching involving clock frequency and/or modulation type (e.g. PWM or PDM). The applied clock frequency is preferably much higher that the highest sound frequency to be generated. The applied clock frequency is thus higher than 40 kHz, such as higher than 100 kHz, such as higher than 300 kHz, such as higher than 1 MHz. Moreover, the control system may be an open or a closed loop configuration.

An enlarged view of two outer feedback loops from the respective sound generating elements 802, 805 is depicted in FIG. 8. As depicted in FIG. 8 each of the sound generating elements 802, 805 comprises a sound generating element 803, 806 and a deflection sensor 804, 807 adapted to measure the deflections of the respective sound generating element 803, 806. The measured deflections are provided to signal conditioners 808, 809 whereby feedback signals 810, 811 are generated. These feedback signals are adapted to be fed into the feedback amplifiers 703, 704 of FIG. 7. FIG. 8 further depicts the drive system 801 and a drive signal 800 provided thereto. As already disclosed the drive system 801 is adapted to provide energy to and/or from the sound generating elements 803, 806.

It should be noted that in case the output of the deflection sensors 804, 807 are linear with the deflection of the sound generating elements 803, 806 no predistortion function is necessary in order to correct for non-linear voltage-to-deflection transfer of the sound generating elements 803, 806. Alternatively, a prediction function may be applied in order to correct for non-linearity of the deflection sensors 804, 807.

In FIGS. 9a-c different embodiments of the sound generating element are depicted.

Referring now to FIG. 9a (top view and cross-sectional view) it is initially noted that FIG. 9a shows a single speaker comprising four triangular cantilever monomorph beams. All four beams are adapted have the same displacement so that the gaps 905, 905′ between the beams do not open when the beams deflect. As seen in FIG. 9a all four beams comprise a top electrodes 903, 903′, 903″, 903′″ arranged on respective piezoelectric layers 902, 902′, 902″, 902″. The top electrodes 903, 903′, 903″, 903′″ may be electrically connected. The respective piezoelectric layers 902, 902′, 902″, 902′″ are arranged on a diaphragm 901 with openings 905, 905′ provided therein in order to separate the four triangular cantilever beams. The diaphragm 901, which forms a common bottom electrode, is supported by a handle 904.

Referring now to FIG. 9b (top view and cross-sectional view) it is noted that FIG. 9b also shows a single speaker seen from the mechanical domain, but a dual speaker when seen from the electrical domain as each of the four triangular cantilever beams comprises a stacked arrangement of two piezoelectric layers 909, 911 and associated top and bottom electrodes. In the embodiment depicted in FIG. 9b the summation of the speaker outputs (for each cantilever beam) is determined by the bending of the entire stack as a result of adding the forces that are generated in the two stacked piezoelectric layers 909, 911. As a consequence, the total air displacement is proportional to the sum of these forces. The relations between input signal and both drive voltages are the same as depicted in FIG. 2a, while the relations between the input signal and generated forces are similar to FIG. 2b (reading “force” instead of “displacement”). The single speaker of FIG. 9b comprises, as already mentioned, four triangular cantilever beams. All four beams are adapted have the same displacement so that the gaps 914, 914′ between the four beams do not open when the beams deflect. As seen in FIG. 9b all four beams comprise two piezoelectric layers 909, 911 each being sandwiched between respective pairs of electrodes with piezoelectric layer 909 being sandwiched between electrodes 908, 910, and piezoelectric layer 911 being sandwiched between electrodes 906, 912. An intermediate dielectric layer 913 is provided between the electrodes 910, 912. The various electrodes are distributed as the top electrode 908, 908′, 908″, 908′″. The electrode 906 is supported by a handle 907.

With respect to FIG. 9c (top view and cross-sectional view) it should be noted that this is also a single speaker seen from the mechanical domain, but a dual speaker when seen from the electrical domain. Each dual speaker comprises of two adjacent cantilever actuators. In FIG. 9c the displacements of four independent trapezoidal cantilever monomorph actuators are coupled to a common passive diaphragm 915. The air displacement of the diaphragm 915 is proportional to the sum of the displacements of the four actuators. Two oppositely arranged actuators are depicted in the cross-sectional view of FIG. 9c where each actuator comprises a piezoelectric layer 919, 919″ sandwiched between a top electrode 917, 917″ and a bottom electrode 918, 918″ arranged on a cantilever beam 920, 920″. The common passive diaphragm 915 is connected to the cantilever beam 920 and the three other cantilever beams via rigid connections 916, 916′, 916″, 916″ surrounded by openings 921, 921′, 921″, 921″. The cantilever beams 920, 920″ are supported by a handle 922. Each of the remaining two actuators also comprises a piezoelectric layer 919′, 919′″ sandwiched between a top electrode 917′, 917′″ and a bottom electrode 918′, 918′″ arranged on a cantilever beam (not shown).

The controllable switches 502, 504 may be implemented in various ways one of them being depicted in FIG. 10 where the input and output terminals are denoted 1001 and 1002, respectively, and where the switch itself and the control signal is denoted 1003 and 1004, respectively. The number of terminals (input and/or output) may be increased from the two depicted in FIG. 10.

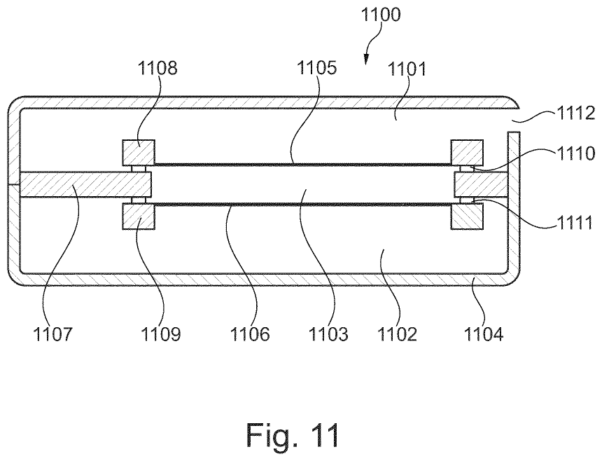

FIG. 11 shows a miniature receiver 1100 comprising a housing 1104 with a sound outlet 1112 arranged therein. The sound outlet 1112 is acoustically connected to a front volume 1101 which is acoustically sealed from a rear volume 1102 via a substrate 1107 and first and second MEMS dies 1108, 1109. The MEMS dies 1108, 1109 are both aligned with an opening in the substrate 1107 as well as secured to the substrate 1107 via respective die attachments 1110, 1111. As seen in FIG. 11 a first sound generating element 1105 forms part of the MEMS die 1108, whereas a second sound generating element 1106 forms part of the MEMS die 1109. The first and second sound generating elements 1105, 1106 are structurally arranged in a substantially parallel manner, i.e. oriented substantially in parallel. Acoustically, the first and second sound generating elements 1105, 1106 are arranged in series.

As depicted in FIG. 11 an upper surface of the first sound generating element 1105 is acoustically connected to the front volume 1101, whereas the opposing lower surface of the first sound generating element 1105 is acoustically connected to the intermediate volume 1103. Similarly, an upper surface of the second sound generating element 1106 is acoustically connected to the intermediate volume 1103, whereas an opposing lower surface of the second sound generating element 1106 is acoustically connected to the rear volume 1102. Thus, the intermediate volume 1103 is arranged between the substantially parallel first and second sound generating elements 1105, 1106.

The intermediate volume 1103 has an intrinsic acoustical compliance which is smaller than the respective acoustical compliances of the first and second sound generating elements 1105, 1106. The smaller acoustical compliance of the intermediate volume 1103 relative to the acoustic compliances of the first and second sound generating elements 1105, 1106 ensure that the first and second sound generating elements 1105, 1106 are driven in the same direction and perform the same volume displacements in response to an applied electrical drive signal.

In terms of implementation the first and second sound generating elements 1105, 1106 each comprises an integrated actuator being adapted to displace the respective first and second sound generating elements 1105, 1106 in response to an electrical drive signal applied thereto. Although not shown in FIG. 11 the actuators of each of the first and second sound generating elements 1105, 1106 may comprise piezoelectric and/or electrostatic drive actuators as previously disclosed. The actuators of the respective first and second sound generating elements 1105, 1106 are electrically driven so that the sum of the stored electrical energies is constant.

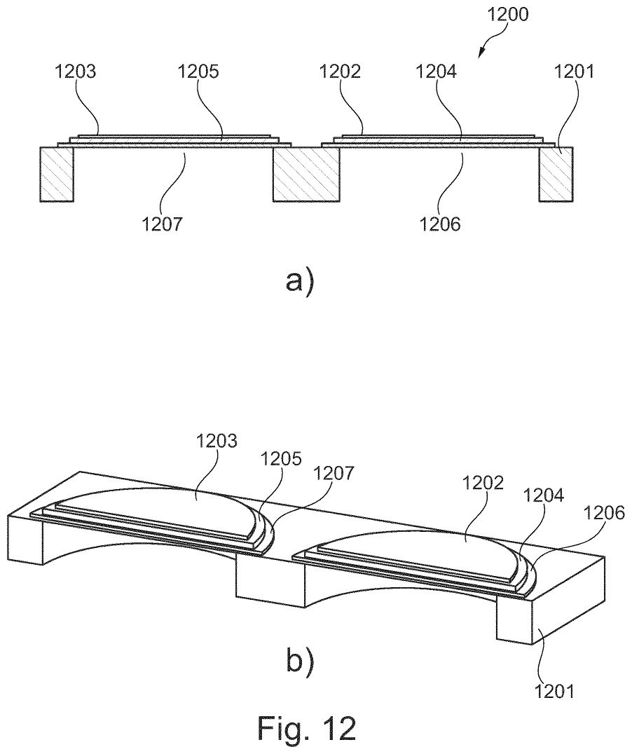

In FIG. 12a a miniature speaker 1200 comprising a MEMS die 1201 and first and second sound generating elements is depicted in a cross-sectional view. The first and second sound generating elements are structurally arranged in a substantially parallel manner. Acoustically, the first and second sound generating elements are also arranged in parallel. As depicted in FIG. 12a each sound generating element comprises an integrated actuator in the form of a piezoelectric layer 1204, 1205 sandwiched between respective upper electrodes 1202, 1203 and respective lower electrodes 1206, 1207. The integrated actuators are adapted to displace the first and second sound generating elements in response to an applied electrical drive signal. The integrated actuators of the first and second sound generating elements may also involve electrostatic actuators.

The upper electrodes 1202, 1203 depicted in FIG. 12a may be acoustically connected to a front volume (not shown), whereas the lower electrodes 1206, 1207 may be acoustically connected to individual rear volumes (not shown). The upper electrodes 1202, 1203 as well as the lower electrodes 1206, 1207 may be electrically connected in parallel, i.e. the upper electrodes 1202, 1203 may be electrically connected, and the lower electrodes 1206, 1207 may be electrically connected.

Turning now to FIG. 12b a three-dimensional illustration of miniature speaker is depicted. Again, the first and second sound generating elements comprise integrated actuators where piezoelectric layers 1204, 1205 are sandwiched between respective upper electrodes 1202, 1203 and respective lower electrodes 1206, 1207.

Although the present invention has been discussed in the foregoing with reference to exemplary embodiments of the invention, the invention is not restricted to these particular embodiments which can be varied in many ways without departing from the invention. The invention thus relates to essentially all types of capacitive speakers. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

### EMBODIMENTS

1. a Miniature Speaker Comprising
   a) a first sound generating element adapted to deflect in response to electrical energy applied thereto,
   b) a second sound generating element adapted to deflect in response to electrical energy applied thereto, and
   c) an energy transferring element adapted to store and release energy when energy is transferred between the first and second sound generating elements at least partly via the energy transferring element.
2. A speaker according to embodiment 1, wherein the sum of the electrical energy in the first sound generating element, the second sound generating element and the energy transferring element is maintained at an essentially constant level over a predetermined time period.
3. A speaker according to embodiment 1, wherein the sum of the deflections of the first sound generating element and the second sound generating element is substantially linear with a drive voltage applied to the first and second sound generating elements.
4. A speaker according to any of the preceding embodiments, wherein the energy transferring element comprises an inductor, and wherein preferably the first and second sound generating elements each comprises a piezoelectric actuator or an electrostatic actuator adapted to deflect the respective sound generating elements.
5. A speaker according to any of the preceding embodiments, wherein the first and second sound generating elements each comprises a deflection sensor adapted to generate an electrical signal in response to deflections of the respective sound generating elements.
6. A speaker according to any of the preceding embodiments, wherein the energy transferring element is furthermore adapted to receive and store energy from an energy source, such as a battery.
7. A speaker according to any of the preceding embodiments, wherein the first and second sound generating elements are discrete and separate mechanical structures with independent accessible electrical terminals.
8. A speaker according to embodiment 7, wherein separated rear volumes are associated with the first and second sound generating elements.
9. A speaker according to embodiment 7 or 8, wherein the first and second sound generating elements are acoustically arranged in parallel, preferably in a single die.
10. A speaker according to any of embodiments 1-6, wherein the first and second sound generating elements have independent accessible electrical terminals, and wherein the first and second sound generating elements each form a bimorph or multimorph mechanical structure where piezoelectric or electrostatic actuators of the first and second sound generating elements form a stacked mechanical structure.
11. A speaker according to embodiment 10, wherein the first and second sound generating elements are acoustically arranged in series.
12. A speaker according to any of the preceding embodiments, further comprising a controllable switching arrangement operatively connected to at least the energy transferring element and the first and second sound generating elements, wherein the controllable switching arrangement is adapted to facilitate the transfer of energy between at least the first sound generating element, the second sound generating element and the energy transferring element.
13. A speaker according to embodiment 11 or 12, further comprising a controller adapted to control the controllable switching arrangement, preferably in a predetermined manner or sequence.
14. A speaker according to embodiment 13, wherein the controller is adapted to switch the controllable switching arrangement between the following states:
   state a) wherein the controllable switching arrangement is arranged to transfer electrical energy from the first sound generating element to the inductor;
   state b) wherein the controllable switching arrangement is arranged to transfer electrical energy from the inductor to the second sound generating element;
   state c) wherein the controllable switching arrangement is arranged to transfer electrical energy from the second sound generating element to the inductor; and
   state d) wherein the controllable switching arrangement is arranged to transfer electrical energy from the inductor to the first sound generating element.
15. A speaker according to the combination of embodiments 6 and 13, wherein the controller is further adapted to switch the controllable switching arrangement between the states a)-d) and a further state e), wherein in state e) the controllable switching arrangement is arranged to transfer electrical energy from the energy source to the inductor.
16. A speaker according to any of the preceding embodiments, wherein a first one of the sound generating elements is adapted to generate a positive pressure on a sound outlet of the speaker when a positive drive voltage relative is applied to said first one of the sound generating elements, whereas the other sound generating element is adapted to generate a positive pressure on the sound outlet when a negative drive voltage is applied to said other sound generating element.
17. A speaker according to any of the preceding embodiments, wherein the first and second sound generating elements are of equal size.
18. A method for operating a miniature speaker comprising a first sound generating element adapted to deflect in response to electrical energy applied thereto, a second sound generating element adapted to deflect in response to electrical energy applied thereto, and an energy transferring element adapted to store and release energy, the method comprising the step of transferring energy between the first and second sound generating elements at least partly via the energy transferring element.
19. A method according to embodiment 18, wherein the sum of the electrical energy in the first sound generating element, the second sound generating element and the energy transferring element is maintained at an essentially constant level over a predetermined time period.
20. A method according to embodiment 18 or 19, wherein the step of transferring energy between the first and second sound generating elements comprises the steps of
   1) transferring energy from the first sound generating element to the energy transferring element for temporary storage therein, and
   2) releasing at least part of the temporary stored energy in the energy transferring element and transferring the released energy to the second sound generating element.
21. A method according to embodiment 20, wherein the step of transferring energy between the first and second sound generating elements further comprises the steps of
   1) transferring energy from the second sound generating element to the energy transferring element for temporary storage therein, and
   2) releasing at least part of the temporary stored energy in the energy transferring element and transferring the released energy to the first sound generating element.
22. A method according to any of embodiment 18-21, further comprising the step of transferring energy to the energy transferring element from an energy source, such as a battery.
23. A method according to any of embodiments 18-22, wherein energy is transferred at least between the first sound generating element, the second sound generating element and the energy transferring element using a controllable switching arrangement operatively connected to at least the energy transferring element and the first and second sound generating elements.
24. A hearing device comprising a speaker according to any of embodiments 1-17.

1. A capacitive MEMS speaker comprising
a) a first sound generating element adapted to deflect in response to electrical energy applied thereto,
b) a second sound generating element adapted to deflect in response to electrical energy applied thereto,
c) an inductor adapted to store and release electrical energy when electrical energy is transferred between the first and second sound generating elements at least partly via the inductor,
d) a controllable switching arrangement operatively connected to at least the inductor and the first and second sound generating elements, wherein the controllable switching arrangement is adapted to facilitate the transfer of electrical energy between at least the first sound generating element, the second sound generating element and the inductor, and
e) a controller adapted to control the controllable switching arrangement to switch with a clock frequency higher than 40 kHz,
wherein the sum of the deflections of the first sound generating element and the second sound generating element is substantially linear with a drive voltage applied to the first and second sound generating elements.

2. A speaker according to claim 1, wherein the sum of the electrical energy in the first sound generating element, the second sound generating element and the inductor is maintained at an essentially constant level over a predetermined time period.

3. A speaker according to claim 1, wherein the first and second sound generating elements each comprises a piezoelectric actuator or an electrostatic actuator adapted to deflect the respective sound generating elements.

4. A speaker according to claim 1, wherein the first and second sound generating elements each comprises a deflection sensor adapted to generate an electrical signal in response to deflections of the respective sound generating elements.

5. A speaker according to claim 1, wherein the inductor is furthermore adapted to receive and store electrical energy from an energy source, such as a battery.

6. A speaker according to any claim 1, wherein the first and second sound generating elements are discrete and separate mechanical structures with independent accessible electrical terminals.

7. A speaker according to claim 6, wherein separated rear volumes are associated with the first and second sound generating elements.

8. A speaker according to claim 6, wherein the first and second sound generating elements are acoustically arranged in parallel, preferably in a single die.

9. A speaker according to claim 1, wherein the first and second sound generating elements have independent accessible electrical terminals, and wherein the first and second sound generating elements each form a bimorph or multimorph mechanical structure where piezoelectric or electrostatic actuators of the first and second sound generating elements form a stacked mechanical structure.

10. A speaker according to claim 9, wherein the first and second sound generating elements are acoustically arranged in series.

11. The speaker according to claim 1, further comprising a controller adapted to switch the controllable switching arrangement between the following states:
state a) wherein the controllable switching arrangement is arranged to transfer electrical energy from the first sound generating element to the inductor;
state b) wherein the controllable switching arrangement is arranged to transfer electrical energy from the inductor to the second sound generating element;
state c) wherein the controllable switching arrangement is arranged to transfer electrical energy from the second sound generating element to the inductor;
state d) wherein the controllable switching arrangement is arranged to transfer electrical energy from the inductor to the first sound generating element; and
state e) wherein the controllable switching arrangement is arranged to transfer electrical energy from the energy source to the inductor.

12. The speaker according to claim 1, wherein the first sound generating element is adapted to generate a positive pressure on a sound outlet of the speaker when a positive drive voltage is applied to the first sound generating element, whereas the second sound generating element is adapted to generate a positive pressure on the sound outlet when a negative drive voltage is applied to the second sound generating element.

13. A method for operating a capacitive MEMS speaker comprising a first sound generating element adapted to deflect in response to electrical energy applied thereto, a second sound generating element adapted to deflect in response to electrical energy applied thereto, an inductor adapted to store and release electrical energy, and a switching arrangement operatively connected to at least the inductor and the first and second sound generating elements, the method comprising the step of transferring electrical energy between the first and second sound generating elements at least partly via the inductor, wherein the method further comprises controlling the switching arrangement to switch with a clock frequency higher than 40 kHz, wherein the sum of the deflections of the first sound generating element and the second sound generating element is substantially linear with a drive voltage applied to the first and second sound generating elements.

14. A method according to claim 13, wherein the sum of the electrical energy in the first sound generating element, the second sound generating element and the inductor is maintained at an essentially constant level over a predetermined time period.

15. A method according to claim 13, wherein the step of transferring electrical energy between the first and second sound generating elements comprises the steps of
transferring electrical energy from the first sound generating element to the inductor for temporary storage therein, and
releasing at least part of the temporary stored electrical energy in the inductor and transferring the released electrical energy to the second sound generating element.

16. A method according to claim 15, wherein the step of transferring electrical energy between the first and second sound generating elements further comprises the steps of
transferring electrical energy from the second sound generating element to the inductor for temporary storage therein, and
releasing at least part of the temporary stored electrical energy in the inductor and transferring the released electrical energy to the first sound generating element.

17. A method according to claim 13, further comprising the step of transferring electrical energy to the inductor from an energy source, such as a battery.

18. A hearing device comprising a speaker according to claim 1.
